(19) United States
(12) Patent Application Publication
(10) Pub. No.: US 2026/0348720 A1
(43) Pub. Date: Nov. 5, 2026

(54) SURFACE TOPOGRAPHY MEASUREMENT SYSTEM AND METHOD

(71) Applicants: Szu-Ye LIN, Taoyuan City (TW); Wei-Che CHANG, Taoyuan City (TW); Tao-Hsuan HAN, Taoyuan City (TW); Li-Yao CHEN, Taoyuan City (TW)

(72) Inventors: Szu-Ye LIN, Taoyuan City (TW); Wei-Che CHANG, Taoyuan City (TW); Tao-Hsuan HAN, Taoyuan City (TW); Li-Yao CHEN, Taoyuan City (TW)

(21) Appl. No.: 19/649,107

(22) Filed: Apr. 15, 2026

(30) Foreign Application Priority Data
Apr. 18, 2025 (TW) 114114683

(51) Int. Cl. G01B 11/06

(52) U.S. Cl. CPC G01B 11/0608

(57) ABSTRACT

The invention discloses a surface topography measurement system and method. The surface topography measurement method comprises: setting, by a control module, a synchronous scanning area and a jump scanning area on the object surface according to a scanning script; in the synchronous scanning area, performing synchronous scanning by an interferometer at a first shifting speed, and generating a plurality of interference images by a photographic device, wherein the plurality of interference images are associated with a reference light provided by an interferometer and multiple object reflection lights reflected from the object surface; and in the jump scanning area, first moving the interferometer at a second shifting speed without generating interference images by the photographic device, and then performing synchronous scanning by the interferometer at the first shifting speed and generating the interference images by the photographic device; wherein the second shifting speed is greater than the first shifting speed.

### CROSS REFERENCE TO RELATED APPLICATION

The present application claims priority to Taiwan patent application Serial No. 114114683 filed on Apr. 18, 2025 the entire content of which is incorporated by reference to this application.

### BACKGROUND OF THE INVENTION

### 1. Field of the invention

The present invention relates to a surface topography measurement system and method, and more particularly to a surface topography measurement system and method capable of accelerating a scanning speed at a high step-height edge.

### 2. Description of the prior art

In existing surface topography measurement technologies, interferometry is widely applied to measure height distributions and structural characteristics of an object surface. Generally speaking, a traditional surface topography measurement system usually performs continuous scanning at a fixed speed during a scanning process, and records one interference image at each depth position, thereby generating complete surface topography data. The number of interference images generated by the traditional surface topography measurement system is huge, which imposes extremely high demands on memory and data processing capabilities, easily causing a processing speed bottleneck, especially in equipment with limited memory capacity. However, although this layer-by-layer scanning method has high accuracy when measuring shallow structures, the scanning efficiency significantly drops when encountering high-depth structures such as through-holes and a redistribution layer (RDL).

The reason is that the traditional surface topography measurement system must scan all depth points, which means that the scanning process includes regions inside the through-holes or the redistribution layer. Those skilled in the art can understand that scanning the regions inside the through-holes or the redistribution layer does not generate effective interference images, but instead leads to a waste of time and resources. To solve the aforementioned problems, there is a need in the industry for a new surface topography measurement system and method capable of improving measurement efficiency, reducing memory requirements, and adapting to different structural characteristics.

### SUMMARY OF THE INVENTION

The present invention provides a surface topography measurement system, which can precisely measure an object surface under general conditions according to a known scanning script, and can also selectively accelerate a scanning speed when encountering a specific structure. For cases where the object surface has a high-depth structure or a protruding structure, the surface topography measurement system of the present invention can optimize the scanning process, shorten measurement time, and reduce memory usage.

The present invention proposes a surface topography measurement system, comprising a light source, an interferometer, a photographic device, and a control module. The light source is configured to provide a test light. The interferometer is configured to split the test light into a first sub-light and a second sub-light, the first sub-light directed toward a reference mirror and reflecting a reference light, the second sub-light directed toward an object surface and reflecting a plurality of object reflection lights, wherein the plurality of object reflection lights correspond to different measurement heights of the interferometer in a first axial direction. The photographic device is configured to receive the reference light and the plurality of object reflection lights to selectively generate a plurality of interference images. The control module is electrically connected to the interferometer and the photographic device, and is configured to set the interferometer and the photographic device to operate in a first scanning mode or a second scanning mode according to a scanning script. Wherein in the first scanning mode, the measurement height of the interferometer changes at a first shifting speed and the photographic device records the plurality of interference images. Wherein in the second scanning mode, the measurement height of the interferometer changes at a second shifting speed and the photographic device does not record the plurality of interference images, the second shifting speed being greater than the first shifting speed.

In some embodiments, the scanning script can be associated with a current structure of the object surface, and when the scanning script indicates that the current structure is a through-hole edge, the control module can set the interferometer and the photographic device to sequentially operate in the second scanning mode and the first scanning mode. When the scanning script indicates that the current structure is not the through-hole edge, the control module can set the interferometer and the photographic device to operate in the first scanning mode. A jump time of the second scanning mode can be associated with the current structure indicated by the scanning script.

In some embodiments, the control module can be further configured to set the interferometer and the photographic device to operate in a third scanning mode to generate the scanning script, wherein in the third scanning mode, the interferometer moves in the first axial direction at a third shifting speed and the photographic device records the plurality of interference images, the third shifting speed being greater than the first shifting speed. Each of the plurality of interference images is associated with an interference fringe pattern of the reference light and the corresponding object reflection light, and the control module can determine the current structure according to the plurality of interference images generated by the third scanning mode. The measurement height of the interferometer is associated with a position of the interferometer in the first axial direction, and the first shifting speed or the second shifting speed of the measurement height of the interferometer can be a moving speed of the interferometer in the first axial direction.

The present invention provides a surface topography measurement method. By introducing a dual-modal design of synchronous scanning and jump scanning, combined with a known scanning script, highly efficient and precise surface topography measurement can be achieved. For cases where the object surface has a high-depth structure or a protruding structure, the surface topography measurement method of the present invention can optimize the scanning process, shorten measurement time, and reduce memory usage.

The present invention proposes a surface topography measurement method for a surface topography measurement system, the surface topography measurement system provided with an interferometer, a photographic device, and a control module, the surface topography measurement method comprising: setting, by the control module, a synchronous scanning area and a jump scanning area on an object surface according to a scanning script; in the synchronous scanning area, performing synchronous scanning by the interferometer at a first shifting speed, and generating a plurality of interference images by the photographic device, wherein the plurality of interference images are associated with a reference light provided by the interferometer and a plurality of object reflection lights reflected from the object surface; and in the jump scanning area, first moving the interferometer at a second shifting speed without generating interference images by the photographic device, and then performing synchronous scanning by the interferometer at the first shifting speed and generating the interference images by the photographic device; wherein the second shifting speed is greater than the first shifting speed.

In some embodiments, the synchronous scanning performed by the interferometer at the first shifting speed means that when the interferometer provides the reference light and each object reflection light, a corresponding one of the interference images can be synchronously generated by the photographic device. The scanning script is associated with a current structure of the object surface, and when the scanning script indicates that the current structure is a through-hole edge, the control module can set the through-hole edge as the jump scanning area. When the scanning script indicates that the current structure is the through-hole edge, a jump time for the interferometer to perform jump scanning at the second shifting speed can be associated with a through-hole depth.

In summary, the surface topography measurement system and method provided by the present invention are applicable to semiconductor manufacturing, optical component processing, or other application scenarios requiring precise measurement of object surface structures. When the object surface has a high-depth structure such as a through-hole or a protruding structure such as a redistribution layer, the surface topography measurement system and method of the present invention can accelerate a scanning speed for a through-hole edge or a protruding structure edge, thereby improving overall measurement efficiency.

### BRIEF DESCRIPTION OF THE APPTERMINALED DRAWINGS

FIG. 1 is a schematic diagram illustrating a surface topography measurement system according to an embodiment of the present invention.

FIG. 2 is a schematic diagram illustrating that an object surface is a through-hole edge.

FIG. 3 is a schematic diagram illustrating that an object surface is a protruding structure edge.

FIG. 4 is a step flowchart illustrating a surface topography measurement method according to an embodiment of the present invention.

### DETAILED DESCRIPTION OF THE INVENTION

The features, targetions, and functions of the present invention are further disclosed below. However, it is only a few of the possible embodiments of the present invention, and the scope of the present invention is not limited thereto; that is, the equivalent changes and modifications done in accordance with the claims of the present invention will remain the subject of the present invention. Without departing from the spirit and scope of the invention, it should be considered as further enablement of the invention.

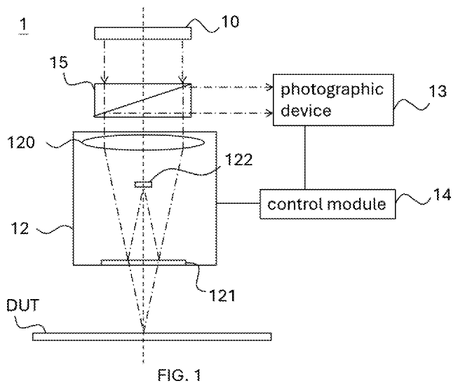

Please refer to FIG. 1, which is a schematic diagram illustrating a surface topography measurement system according to an embodiment of the present invention. As shown in FIG. 1, the surface topography measurement system 1 of the present invention includes a light source 10, an interferometer 12, a photographic device 13, and a control module 14. The light source 10 can provide a test light to the interferometer 12, the interferometer 12 scans an object surface DUT, and the photographic device 13 receives a reference light and a plurality of object lights returning from the interferometer 12 to generate a plurality of interference images. The control module 14 can analyze the plurality of interference images to determine a surface topography of the object surface DUT. Practically, a beamsplitter 15 can be disposed between the light source 10 and the interferometer 12. The beamsplitter 15 is used to guide light emitted from the light source 10 toward the interferometer 12, as well as light returning from the interferometer 12 and directed toward the photographic device 13. Each component of the surface topography measurement system 1 is described respectively below.

The light source 10 is used to provide the test light, and the test light can be a collimated light. In one example, the light source 10 can be a broadband white-light LED or a monochromatic laser light source, and a specific type thereof is determined according to reflection characteristics and accuracy requirements of the object surface DUT, which is not limited in the present embodiment. In addition, an interferometer 12 is disposed on an optical path of the test light. The interferometer 12 can be an optical interferometer, such as a common Mirau interferometer, a Linnik interferometer, or a Michelson interferometer. For convenience of description, the present embodiment takes the Mirau interferometer as an example, but those skilled in the art can understand that the interferometer 12 is not limited to the Mirau interferometer. The interferometer 12 comprises an objective lens 120, a beamsplitter 121, and a reference mirror 122. Herein, the objective lens 120 can be a microscope objective used to focus the test light; the beamsplitter 121 is used to allow a portion of the test light to be reflected toward the reference mirror 122, and the beamsplitter 121 can also allow another portion of the test light to penetrate therethrough. Herein, the portion of the test light reflected toward the reference mirror 122 can be referred to as a first sub-light, and the portion of the test light penetrating through the beamsplitter 121 can be referred to as a second sub-light. Practically, light resulting from the first sub-light being reflected by the reference mirror 122 is referred to as a reference light in the present embodiment. The second sub-light is directed toward the object surface DUT, and light reflected by the object surface DUT can be referred to as object reflection lights. The object reflection lights correspond to different depth positions of the interferometer along a first axial direction (i.e., Z-axis).

The control module 14 can control a measurement height of the interferometer 12, and scanning by the interferometer 12 at a plurality of measurement heights can respectively correspond to a plurality of object reflection lights. The photographic device 13 can capture light returning from the interferometer 12, such as the reference light and the plurality of object reflection lights. Since an optical path difference may exist where the reference light and each of the object reflection lights arrive at the photographic device 13, distinct or indistinct interference fringe patterns may be seen in images captured by the photographic device 13. In the present embodiment, a plurality of images respectively captured by the photographic device 13 corresponding to the plurality of object reflection lights are all referred to as interference images. Those skilled in the art should be able to understand that the control module 14 can determine heights and depressions of the object surface DUT according to the interference fringe patterns in the plurality of interference images, thereby obtaining the surface topography of the object surface DUT. For example, the control module 14 can determine which interference image has the best clarity of the interference fringe pattern based on grayscale values or contrast, thereby calculating the surface topography of the object surface DUT from the corresponding measurement height of the interferometer 12.

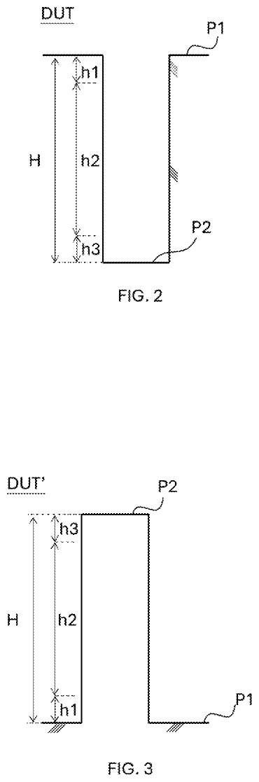

Different from traditional surface topography measurement systems, the control module 14 of the surface topography measurement system 1 of the present embodiment is optimized to more effectively measure a specific structure of the object surface DUT, such as for measuring a through-hole. Please refer to FIG. 1 and FIG. 2 together. FIG. 2 is a schematic diagram illustrating that an object surface is a through-hole edge. Taking the example of FIG. 2, the object surface DUT is illustrated with a through-hole, and the through-hole has an upper surface and a lower surface with a step height (depth H), which are an upper layer surface P1 corresponding to a through-hole opening and a lower layer surface P2 corresponding to a bottom of the through-hole, respectively. Taking a through-hole with a step height of 175 micrometers as an example, some traditional surface topography measurement systems require nearly 100 seconds to complete the entire measurement process, because the scanning process includes a hollow region inside the through-hole. The surface topography measurement system 1 of the present embodiment can efficiently and precisely measure the surface topography of the object surface DUT, and is particularly optimized in design for objects having high-depth structures such as through-holes. The through-hole referred to in the present embodiment serves as an example of a recessed structure. Practically, the recessed structure may also include a trench or various functional through-holes and vias, such as a through interposer via (TIV), a through silicon via (TSV), a through glass via (TGV), or other vertical vias, which is not limited in the present embodiment.

In detail, the control module 14 is electrically connected to the interferometer 12 and the photographic device 13 respectively, and switches operating modes of the interferometer 12 and the photographic device 13 according to a scanning script, including a first scanning mode and a second scanning mode. Assuming that the object surface DUT is a wafer surface, and the scanning script is prepared in advance (a known layout of the object surface DUT). In one example, the scanning script described in the present embodiment can pre-define one or more synchronous scanning areas and one or more jump scanning areas. Practically, the scanning script can pre-partition areas on the object surface DUT; for example, when the depth of the through-hole is along the Z-axis, areas can be partitioned on the XY-plane. A criterion for partitioning areas can be that as long as the object surface DUT is not a through-hole edge, it can be classified as a synchronous scanning area, and only the through-hole edge is partitioned as a jump scanning area, which is not limited in the present embodiment.

At this time, the control module 14 can first know a structure to be scanned next (current structure) from the scanning script. If the current structure corresponds to a flat surface or a structure with little height variation, belonging to a synchronous scanning area of the scanning script of the object surface DUT, the control module 14 can control the interferometer 12 and the photographic device 13 to use the first scanning mode throughout the entire process to ensure data continuity. Practically, the first scanning mode means that the measurement height of the interferometer 12 changes at a lower first shifting speed, and the photographic device 13 records an interference image of the object reflection light and the reference light returning at each measurement height to obtain fine surface data of the object surface DUT. Herein, a single change in the measurement height of the interferometer 12 with synchronous generation or recording of a corresponding interference image by the photographic device 13 can be referred to as synchronous scanning. In other words, when the current structure is not a structure having a large step height (such as not being a through-hole edge), the control module 14 can allow the interferometer 12 and the photographic device 13 to perform synchronous scanning throughout the entire process to ensure accuracy in scanning the object surface DUT.

Relatively, if the current structure corresponds to a through-hole edge or a structure with large height variations, belonging to a jump scanning area of the object surface DUT, the control module 14 can control the interferometer 12 and the photographic device 13 to sequentially use the second scanning mode and the first scanning mode. Taking the example of FIG. 2, the control module 14 knows from the scanning script that a through-hole edge is currently to be scanned, and the through-hole can have a depth H. At this time, at a measurement height adjacent to the upper layer surface P1 of the through-hole opening (from the upper layer surface P1 to a depth h1), the control module 14 can first set the interferometer 12 and the photographic device 13 to perform synchronous scanning, ensuring that a structure of the upper layer surface P1 is completely scanned.

Next, at a measurement height corresponding to a hollow region of the through-hole (depth h2), the control module 14 can control the interferometer 12 and the photographic device 13 to use the second scanning mode. Practically, the second scanning mode means that the measurement height of the interferometer 12 changes at a higher second shifting speed, and the photographic device 13 does not record interference images. For example, because the photographic device 13 does not record interference images, in addition to saving data storage space, the interferometer 12 can move the measurement height more rapidly without waiting for processing by the photographic device 13. Therefore, the second shifting speed can be much greater than the first shifting speed; or rather, when comparing an amount of change in the measurement height of the interferometer 12 per unit time, an amount of change in the measurement height of the second scanning mode is much greater than an amount of change in the measurement height of the first scanning mode. In a practical example, the second shifting speed can be, for example, 1 mm/s, and the first shifting speed can be, for example, 0.1 mm/s.

A jump distance of the second scanning mode is associated with the through-hole depth H, and particularly associated with the depth h2. Those skilled in the art can understand that the control module 14 can calculate how long the second scanning mode should last (i.e., a jump time) from the known second shifting speed and the known depth h2. At this time, because the photographic device 13 does not record interference images, the absence of data storage significantly reduces memory usage. Since the control module 14 can know an approximate depth H of the through-hole from the scanning script, when the measurement height is about to approach the bottom of the through-hole, for example, when the measurement height is at a depth h3, the control module 14 can control the interferometer 12 and the photographic device 13 to switch back to the first scanning mode. The definition of the first scanning mode in the present embodiment is as described above; that is, the interferometer 12 and the photographic device 13 at this measurement height (depth h3) can resume performing synchronous scanning, ensuring that a structure of the lower layer surface P2 can be completely scanned when adjacent to the lower layer surface P2. As can be known from the above, when the control module 14 determines that the current structure is a through-hole edge, it first skips the hollow region of the through-hole (depth h2) without performing synchronous scanning (the second scanning mode), and performs synchronous scanning (the first scanning mode) only when approaching the bottom of the through-hole. In one example, the manner in which the interferometer 12 and the photographic device 13 first operate in the second scanning mode and then operate in the first scanning mode is referred to as jump scanning in the present embodiment.

As described previously in the present embodiment, when scanning to a through-hole edge (jump scanning area), the surface topography measurement system 1 first performs synchronous scanning when the measurement height corresponds to a range of the depth h1, then performs jump scanning when the measurement height corresponds to a range of the depth h2 (depth h2), and then performs synchronous scanning again when the measurement height corresponds to a range of the depth h3 (depth h3). However, as long as the surface topography measurement system 1 performs jump scanning at least once on the object surface DUT—that is, the interferometer 12 and the photographic device 13 switch from the second scanning mode to the first scanning mode at least once—a position where the jump scanning is performed shall conform to a definition of the jump scanning area in the present embodiment. In other words, the surface topography measurement system 1 of the present embodiment resumes a conventional synchronous scanning speed after skipping a section of depth distance. Because high-speed scanning is performed through the skipped depth without data storage, memory can be significantly saved, adapting to an environment with limited memory capacity. Taking a measurement of a 175-micrometer-deep through-hole as an example, when measuring with the surface topography measurement system 1 of the present embodiment, an overall time consumption can be significantly reduced from nearly 100 seconds traditionally to within 13.5 seconds.

On the other hand, the surface topography measurement system 1 can change the measurement height of the interferometer 12 in several manners; for example, an optical means can be used to change an optical path of the object reflection light in the first axial direction (Z-axis) without moving an overall position of the interferometer 12; alternatively, an actual position of the interferometer 12 in the first axial direction (Z-axis) can be directly moved to change the optical path of the object reflection light in the first axial direction (Z-axis), which is not limited in the present embodiment. It is worth mentioning that the reason why the surface topography measurement system 1 of the present embodiment can significantly improve measurement efficiency is that the control module 14 obtains the scanning script and knows through-hole positions in advance. These positions can be provided by a manufacturer or a scanning script can be compiled based on previous data, directly applied to measurements of a same series of wafers. In addition, if an error occurs in the scanning script—for example, an expected measurement value is not measured at a position that should be a through-hole edge—the control module 14 can activate a fast-scan mechanism to scan at larger intervals and higher speeds, quickly locating anomalies.

In one example, the surface topography measurement system 1 of the present invention can compile a scanning script, for example, by employing a third scanning mode as an initial detection step. For example, when measuring a new object surface or when an error occurs in an original scanning script, and no applicable scanning script is available at this time, the control module 14 can choose to activate the third scanning mode. The interferometer 12 moves along the first axial direction at a third shifting speed (e.g., 0.5 mm/s, between the first and second shifting speeds), and the photographic device 13 can choose to record interference images at larger time intervals. By analyzing variations of the interference fringe patterns within the interference images, the control module 14 determines a structure; for example, an indistinct or disappearing interference fringe pattern indicates being inside a through-hole, and a distinct interference fringe pattern indicates presence of a surface (which could be a through-hole opening or a bottom), thereby generating a new scanning script. Practically, the third scanning mode aims to quickly obtain a structural overview or perform anomaly troubleshooting. Because a data volume thereof is less than that of synchronous scanning, a demand on memory is also relatively low, making it particularly suitable for pre-compiling a scanning script. In addition, a compiled scanning script can be stored in a memory of the control module 14 and can be repeatedly used for subsequent measurements, which is applicable to batch wafer inspection.

Similarly, the present invention is not only applicable to through-holes, but can be further applicable to protruding structures. Please refer to FIG. 1 and FIG. 3 together. FIG. 3 is a schematic diagram illustrating that an object surface is a protruding structure edge. Taking the example of FIG. 3, the object surface DUT′ is illustrated with a protruding structure, and the protruding structure has an upper surface and a lower surface with a step height (depth H), which are a surface P1 corresponding to a bottom of the protruding structure and a surface P2 corresponding to a top of the protruding structure, respectively. The scanning script described in the present embodiment can likewise pre-define one or more synchronous scanning areas and one or more jump scanning areas. Practically, the scanning script can pre-partition areas on the object surface DUT′; for example, when a height of the protruding structure is along the Z-axis, areas can be partitioned on the XY-plane. A criterion for partitioning areas can be that as long as the object surface DUT′ is not a protruding structure edge, it can be classified as a synchronous scanning area, and only the protruding structure edge is partitioned as a jump scanning area, which is not limited in the present embodiment.

Taking the example of FIG. 3, the control module 14 knows from the scanning script that a protruding structure edge is currently to be scanned, and the protruding structure can have a height H. At this time, at a measurement height adjacent to the surface P1 of the bottom of the protruding structure (from the surface P1 to a height h1), the control module 14 can first set the interferometer 12 and the photographic device 13 to perform synchronous scanning, ensuring that a structure of the surface P1 is completely scanned. Next, at a measurement height corresponding to a middle region of the protruding structure (height h2), the control module 14 can control the interferometer 12 and the photographic device 13 to use the second scanning mode. Practically, the second scanning mode means that the measurement height of the interferometer 12 changes at a higher second shifting speed, and the photographic device 13 does not record interference images. Since the control module 14 can likewise know an approximate height H of the protruding structure from the scanning script, when the measurement height is about to approach the top of the protruding structure, for example, when the measurement height is at a height h3, the control module 14 can control the interferometer 12 and the photographic device 13 to switch back to the first scanning mode. The definition of the first scanning mode in the present embodiment is as described above; that is, the interferometer 12 and the photographic device 13 at this measurement height (height h3) can resume performing synchronous scanning, ensuring that a structure of the surface P2 can be completely scanned when adjacent to the surface P2. As can be known from the above, when the control module 14 determines that the current structure is a protruding structure, it first skips the middle region of the protruding structure (height h2) without performing synchronous scanning (the second scanning mode), and performs synchronous scanning (the first scanning mode) only when approaching the top of the protruding structure. The protruding structure referred to in the present embodiment can practically be a redistribution layer (RDL), a bump, or a pillar, which is not limited in the present embodiment.

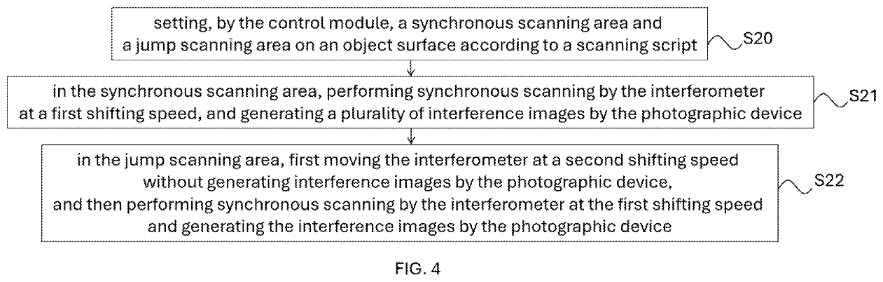

For convenience of description of the surface topography measurement method of the present invention, please refer to FIG. 1 to FIG. 4 together. FIG. 4 is a step flowchart illustrating a surface topography measurement method according to an embodiment of the present invention. As shown in the figure, a surface topography measurement method is applicable to a surface topography measurement system, the surface topography measurement system provided with an interferometer, a photographic device, and a control module, the surface topography measurement method comprising: in step S20, setting, by the control module, a synchronous scanning area and a jump scanning area on an object surface according to a scanning script; in step S22, in the synchronous scanning area, performing synchronous scanning by the interferometer at a first shifting speed, and generating a plurality of interference images by the photographic device, wherein the plurality of interference images are associated with a reference light provided by the interferometer and a plurality of object reflection lights reflected from the object surface; and in step S24, in the jump scanning area, first moving the interferometer at a second shifting speed without generating interference images by the photographic device, and then performing synchronous scanning by the interferometer at the first shifting speed and generating the interference images by the photographic device; wherein the second shifting speed is greater than the first shifting speed.

In summary, the surface topography measurement system and method provided by the present invention are applicable to semiconductor manufacturing, optical component processing, or other application scenarios requiring precise measurement of object surface structures. When the object surface has a high-depth structure such as a through-hole, the surface topography measurement system and method of the present invention can accelerate a scanning speed for the through-hole edge, thereby improving overall measurement efficiency.

What is claimed is:

1. A surface topography measurement system, comprising:
a light source configured to provide a test light;
an interferometer configured to split the test light into a first sub-light and a second sub-light, the first sub-light directed toward a reference mirror and reflecting a reference light, the second sub-light directed toward an object surface and reflecting a plurality of object reflection lights, wherein the plurality of object reflection lights correspond to different measurement heights of the interferometer in a first axial direction;
a photographic device configured to receive the reference light and the plurality of object reflection lights to selectively generate a plurality of interference images; and
a control module electrically connected to the interferometer and the photographic device, the control module configured to set the interferometer and the photographic device to operate in a first scanning mode or a second scanning mode according to a scanning script;
wherein in the first scanning mode, the measurement height of the interferometer changes at a first shifting speed and the photographic device records the plurality of interference images; and
wherein in the second scanning mode, the measurement height of the interferometer changes at a second shifting speed and the photographic device does not record the plurality of interference images, the second shifting speed being greater than the first shifting speed.

2. The surface topography measurement system according to claim 1, wherein the scanning script is associated with a current structure of the object surface, and when the scanning script indicates that the current structure is a through-hole edge or a protruding structure edge, the control module sets the interferometer and the photographic device to sequentially operate in the second scanning mode and the first scanning mode.

3. The surface topography measurement system according to claim 2, wherein when the scanning script indicates that the current structure is not the through-hole edge or the protruding structure edge, the control module sets the interferometer and the photographic device to operate in the first scanning mode.

4. The surface topography measurement system according to claim 2, wherein a jump time of the second scanning mode is associated with the current structure indicated by the scanning script.

5. The surface topography measurement system according to claim 1, wherein the control module is further configured to set the interferometer and the photographic device to operate in a third scanning mode to generate the scanning script, wherein in the third scanning mode, the interferometer moves in the first axial direction at a third shifting speed and the photographic device records the plurality of interference images, the third shifting speed being greater than the first shifting speed.

6. The surface topography measurement system according to claim 1, wherein each of the plurality of interference images is associated with an interference fringe pattern of the reference light and the corresponding object reflection light, and the control module determines the current structure according to the plurality of interference images generated by the third scanning mode.

7. The surface topography measurement system according to claim 1, wherein the measurement height of the interferometer is associated with a position of the interferometer in the first axial direction, and the first shifting speed or the second shifting speed of the measurement height of the interferometer is a moving speed of the interferometer in the first axial direction.

8. A surface topography measurement method for a surface topography measurement system, the surface topography measurement system provided with an interferometer, a photographic device, and a control module, the surface topography measurement method comprising:
setting, by the control module, a synchronous scanning area and a jump scanning area on an object surface according to a scanning script;
in the synchronous scanning area, performing synchronous scanning by the interferometer at a first shifting speed, and generating a plurality of interference images by the photographic device, wherein the plurality of interference images are associated with a reference light provided by the interferometer and a plurality of object reflection lights reflected from the object surface; and
in the jump scanning area, first moving the interferometer at a second shifting speed without generating interference images by the photographic device, and then performing synchronous scanning by the interferometer at the first shifting speed and generating the interference images by the photographic device;
wherein the second shifting speed is greater than the first shifting speed.

9. The surface topography measurement method according to claim 8, wherein the synchronous scanning performed by the interferometer at the first shifting speed means that when the interferometer provides the reference light and each of the plurality of object reflection lights, a corresponding one of the plurality of interference images is synchronously generated by the photographic device.

10. The surface topography measurement method according to claim 8, wherein the scanning script is associated with a current structure of the object surface, and when the scanning script indicates that the current structure is a through-hole edge or a protruding structure edge, the control module sets the through-hole edge or the protruding structure edge as the jump scanning area.

11. The surface topography measurement method according to claim 10, wherein when the scanning script indicates that the current structure is the through-hole edge or the protruding structure edge, a jump time for the interferometer to perform jump scanning at the second shifting speed is associated with a through-hole depth or a protrusion height.
